(19) United States
(12) Patent Application Publication
(10) Pub. No.: US 2014/0116412 A1
(43) Pub. Date: May 1, 2014

(54) GLASS SUBSTRATE WITH SLIGHTLY ROUGH LAYER

(71) Applicants: Alexandre Popoff, Paris (FR); Bernard Nghiem, Arsy (FR)

(72) Inventors: Alexandre Popoff, Paris (FR); Bernard Nghiem, Arsy (FR)

(73) Assignee: SAINT GOBAIN GLASS FRANCE, Courbevoie (FR)

(21) Appl. No.: 14/009,712

(22) PCT Filed: Mar. 30, 2012
(86) PCT No.: PCT/FR2012/050690

§ 371 Date: Dec. 16, 2013

(30) Foreign Application Priority Data
Apr. 4, 2011 (FR) 1152873

(51) Int. Cl. C03C 17/23; F24C 15/04; B32B 9/04

(52) U.S. Cl. CPC C03C 17/23; B32B 9/04; F24C 15/04
USPC 126/200; 427/255.29; 428/701; 428/336

(57) ABSTRACT

The invention relates to:
a glazing substrate, characterised in that it is equipped with a layer consisting of crystallites of at least 25 nm in size, directly covered with a layer consisting of crystallites of at most 10 nm in size;
its manufacturing process; and
its application to a low-E glazing unit or in solar control.

The present invention relates to coating an inorganic layer that is rough and/or contains surface irregularities that have sharp angles and/or are spiky, which layer is deposited on a substrate, especially a glazing substrate, in the form of an amorphous nanocrystalline layer, in order to reduce or remove the surface roughness and/or round or soften the surface irregularities.

The assembly consisting of the substrate and the layers is, in particular, transparent, the layers providing the assembly with, for example, optical properties (haze, scattering or absorption of light, tint, etc.) and/or thermal properties (low-E, solar control i.e. reflection of part of the solar spectrum, etc.) and/or electrical properties (conductivity, etc.) and/or catalytic properties (self-cleaning, etc.).

For example, producing low-E glazing units for architectural or automotive (cars, etc.) applications requires a transparent conductive oxide (TCO) layer to be deposited on a glazing substrate. A commonly used process consists in depositing fluorine-doped tin oxide by thermal chemical vapour deposition (CVD).

A problem with thermal CVD is that, since the glass is hot, the layer obtained is generally well crystallised, i.e. it mainly comprises relatively large crystallites, and thus has a non-zero surface roughness. Here the term “roughness” denotes, as is widely accepted, the height between the highest points of an irregular surface (peaks) and the lowest points (troughs). This surface roughness results in a high haze value that it would be desirable to avoid in certain applications in which haze is considered aesthetically unattractive or a hindrance to vision.

In addition, the well-crystallised layer obtained contains surface irregularities forming asperities with sharp angles, which are liable to hinder or even prevent the surface from being cleaned.

In photovoltaic-cell electrode applications, such asperities on the surface of a TCO layer may lead to short-circuiting with the underlying active absorbing layer (amorphous silicon, CdTe, etc.). This results in a drop in the performance of the photovoltaic cell, especially reducing open-circuit voltage.

The inventors therefore set themselves the objective of reducing or even removing roughness from such layers obtained on hot glass substrates by thermal CVD and/or of rounding or softening their sharp-angled surface irregularities (forming spikes), optionally without reducing roughness.

This objective is met by the invention, the subject of which is a glazing substrate, characterised in that it is equipped with a layer consisting of crystallites of at least 25 nm in size, directly covered with a layer consisting of crystallites of at most 10 nm in size. According to the invention, a layer consisting of crystallites of at least 25 nm in size, or at most 10 nm in size, mainly consists of crystallites the largest dimension of which is such. A layer consisting of crystallites of at least 25 nm in size results from thermal CVD on glass customarily at about 600° C.

The two layers of the glazing substrate of the invention consist of identical or different materials.

The size of the crystallites is here determined from X-ray diffraction (XRD) measurements carried out on the crystallites layers. The X-ray diffraction apparatus is used in theta-theta mode on a plane parallel to the surface of the sample. The size of the grains is calculated using the Scherrer equation (k=0.9, instrumental broadening determined from fundamental parameters), any widening of the peak being attributed to a size effect (the Pearson-VII profile was used). The size indicated is the minimum size for 25 nm, maximum size for 10 nm, respectively, from the sizes obtained for each of the diffraction peaks.

The thickness of the layer consisting of crystallites of at most 10 nm in size may reach 700 nm; it may even be as high as 2 μm.

The thickness of the layer of crystallites of at least 25 nm in size is not limited; it is for example at most equal to 2 μm, preferably 1.5 μm; and a minimum average thickness of about the size of the crystallites (25 nm) is envisageable.

According to other preferred features of the glazing substrate of the invention:
the thickness of the layer of crystallites of at most 10 nm in size is at most equal to 350 nm, preferably 250 nm; the inventors have observed that a maximum thickness of 350 nm for the coating consisting of crystallites of at most 10 nm in size delivers the effective smoothing desired for the underlying functional layer deposited by thermal CVD, decreasing or even removing the surface roughness and/or rounding small spiky protrusions, optionally without reducing roughness in this case; this effect is still obtained when this layer has a thickness of 100 nm, and even a thickness of 10 or even 5 nm;
the glazing substrate is directly covered with a barrier layer preventing alkali metals from migrating from the glass; the barrier layer is therefore located under the layer consisting of crystallites of at least 25 nm in size, either directly, or with one or more layers interposed; the function of the barrier layer is to prevent layers above it from being contaminated by sodium ions from the glass when the glass is under particular conditions, especially at a high temperature; the barrier layer may be made of silica or silicon oxycarbide (SiOC); and
the layer of crystallites of at least 25 nm in size on the one hand, of at most 10 nm in size on the other hand, is a transparent oxide layer and is, or is not, electrically conductive; by way of examples of transparent conductive oxides, mention may be made of SnO₂:F, SnO₂:Sb, ZnO:Al, ZnO:Ga, InO:Sn, ZnO:In, and by way of examples of transparent non-conductive oxides, SnO₂, ZnO, InO; the transparent oxide forming these layers may be a photocatalytic oxide, such as TiO₂, i.e. it may have properties that initiate radical oxidation under solar radiation (properties that lead to the degradation of hydrocarbons, self-cleaning).

The invention also relates to:
a process for manufacturing a glazing substrate such as defined above, in which the layers consisting of crystallites of at least 25 nm in size and of at most 10 nm in size, respectively, are formed by chemical vapour deposition at a relatively high substrate temperature (especially at least equal to 500° C., preferably 550° C.), and a relatively low substrate temperature (especially at least equal to 300° C. and most equal to 550° C., preferably 500° C.), respectively; and to
application of a glazing substrate such as described above to a low-E architectural or automotive glazing unit, to an item of domestic electrical equipment such as an oven door or a structure comprising a heating layer, or even in solar control, on the face of glazing units making contact with the external atmosphere, the surface of which has a reduced or even zero roughness, and/or rounded and/or softened asperities thereby aiding with cleaning; by way of a solar-control layer, mention may be made of SnO₂:Sb.

The invention is now illustrated by the following example embodiment.

### EXAMPLE

Two deposits were deposited in succession by chemical vapour deposition on a substrate of 1 m in width.

The substrate was made of 4 mm-thick soda-lime float glass sold under the registered trademark Planilux® by Saint-Gobain Glass France, and equipped with a 25 nm SiOC layer forming a barrier preventing alkali metals from migrating from the glass.

The first deposition was carried out under the following conditions:

substrate temperature: 600° C.;

substrate run rate (direction perpendicular to its width): 12 m/min;

flow rate of monobutyltin trichloride (MBTCL): 30 kg/h;

flow rate of water: 7.5 kg/h; and

total flow rate of air (80 vol % nitrogen, 20 vol % oxygen): 1195 1/min.

A 400 nm-thick layer consisting of SnO2 crystallites of at least 25-30 nm in size was obtained. The haze of the coated substrate was 17%.

The second deposition was carried out under the following conditions:

substrate temperature: 450° C.;

substrate run rate: 8 m/min;

the other conditions were identical to those of the first deposition.

A 150 nm-thick second layer consisting of SnO₂ crystallites of about 6 nm in size was obtained. The haze of the substrate coated with the layers of the first and second deposits was 17.1%.

The properties of the substrate were the same as they were before the second layer was deposited after the second deposition. The only change was that the surface was smoother making it easier to clean; it was observed that a cloth-type cleaning means was no longer caught on the asperities with sharp angles of the surface, which were covered and/or rounded to a certain degree.

1. A glazing substrate, equipped with a first transparent oxide layer consisting of crystallites of at least 25 nm in size; and
a second transparent oxide layer consisting of crystallites of at most 10 nm in size wherein the first transparent oxide layer is directly covered with the second transparent oxide layer.

2. The glazing substrate of claim 1, wherein the thickness of the second transparent oxide layer is at most equal to 350 nm.

3. The glazing substrate of claim 1, wherein the thickness of the second transparent oxide layer is at most equal to 250 nm.

4. The glazing substrate of claim 1, further comprising a barrier layer, which directly covers the substrate and prevents alkali metals from migrating from the glass.

5. The glazing substrate of claim 1, wherein the first transparent oxide layer of crystallites and the second transparent oxide layer of crystallites are electrically conductive and selected from the group consisting of SnO₂ :F, SnO₂:Sb, ZnO:Al, ZnO:Ga, InO:Sn, and ZnO:In, or are not electrically conductive and selected from the group consisting of SnO₂, ZnO, and InO.

6. A process for manufacturing the glazing substrate of claim 1, the process comprising:
depositing the first transparent oxide layer consisting of crystallites of at least 25 nm in size by chemical vapour deposition at a relatively high substrate temperature; and
depositing the second transparent oxide layer consisting of crystallites of at most 10 nm in size by chemical vapour deposition at a relatively low substrate temperature.

7. The process of claim 6, wherein the relatively high substrate temperature is at least equal to 500° C.

8. The process of claim 6, wherein the relatively low substrate temperature is at least equal to 300° C. and at most equal to 550° C.

9. A low-E architectural or automotive glazing unit, comprising, on a face making contact with the external atmosphere, the glazing substrate of claim 1.

10. The glazing substrate of claim 1, wherein the first transparent oxide layer of crystallites and the second transparent oxide layer of crystallites are electrically conductive and selected from the group consisting of SnO₂ :F, SnO₂:Sb, ZnO:Ga, InO:Sn, and ZnO:In.

11. The glazing of claim 1, wherein the first transparent oxide layer of crystallites and the second transparent oxide layer of crystallites are not electrically conductive and selected from the group consisting of SnO₂, ZnO, and InO.

12. The glazing of claim 1, wherein the first transparent oxide layer of crystallites and the second transparent oxide layer of crystallites are photocatalytic and formed from TiO₂.

13. The process of claim 6, wherein the relatively high substrate temperature is at least equal to 550° C.

14. The process of claim 6, wherein the relatively low substrate temperature is at least equal to 300° C. and at most equal to 500° C.

15. An oven door or a structure comprising a heating layer comprising, on a face making contact with the external atmosphere, the glazing substrate of claim 1.
